(19) United States
(12) Patent Application Publication
(10) Pub. No.: US 2015/0030911 A1
(43) Pub. Date: Jan. 29, 2015

(54) NON-AQUEOUS ELECTROLYTE SECONDARY BATTERY

(71) Applicant: SANYO Electric Co., Ltd., Moriguchi-shi (JP)

(72) Inventors: Shinya Miyazaki, Hyogo (JP); Kazunori Donoue, Hyogo (JP); Yuji Tani, Hyogo (JP)

(73) Assignee: SANYO Electric Co., Ltd., Moriguchi-shi (JP)

(21) Appl. No.: 14/378,519

(22) PCT Filed: Mar. 13, 2013
(86) PCT No.: PCT/JP2013/056903

§ 371 Date: Aug. 13, 2014

(30) Foreign Application Priority Data
Mar. 15, 2012 (JP) 2012-058060

(51) Int. Cl. H01M 10/04; H01M 4/485; H01M 4/52; H01M 10/0525; H01M 4/50; H01M 2/02; H01M 10/0569

(52) U.S. Cl. CPC H01M 10/0413; H01M 2/024; H01M 4/485; H01M 10/0569; H01M 10/0525; H01M 4/502; H01M 4/523; H01M 2300/0028; H01M 2220/20
USPC 429/163

(57) ABSTRACT

A non-aqueous electrolyte secondary battery comprises a stacked electrode assembly in which the positive electrode plates with a large area and the negative electrode plates with a large area are stacked interposing separators therebetween, and a non-aqueous electrolyte containing non-aqueous solvent. The positive electrode plate as the positive electrode active material comprises a lithium transition-metal composite oxide expressed by Liₐ(Ni_{b}Co_{c}Mn_{d})MₑO₂ (1.05≦a≦1.20, 0.3≦b≦0.6, b+c+d=1, 0≦e≦0.05, and M is at least one element selected from the group consisting of Ti, Nb, Mo, Zn, Al, Sn, Mg, Ca, Sr, Zr, and W), and the proportion of a chain carbonate contained in the non-aqueous solvent to the non-aqueous solvent is 50% by volume or more, and the proportion of diethyl carbonate contained in the chain carbonate to the chain carbonate is 70% by volume or more.

### TECHNICAL FIELD

The present invention is related to a non-aqueous electrolyte secondary battery having a stacked electrode assembly.

### BACKGROUND ART

In recent years, as the drive power sources of mobile or portable electronic equipment such as mobile telephones, portable computers, and portable music players, non-aqueous electrolyte secondary batteries typified by a lithium ion secondary battery are widely used. Further, against a background of the steep rise in crude oil prices and growing environmental protection movements in recent years, electrically powered vehicles using non-aqueous electrolyte batteries such as electric vehicles (EVs), hybrid electric vehicles (HEVs), plug-in hybrid electric vehicles (PHEVs), electric bike or the like are being actively developed. As the secondary battery in large-sized electricity storage systems to store midnight power or solar power generation, medium- or large-sized non-aqueous electrolyte secondary batteries are being developed.

In the non-aqueous electrolyte secondary batteries used in the electrically powered vehicles, the large-sized electricity storage systems, or the like, the high capacity and the high energy density are required, and it is strongly required to improve battery characteristics (load characteristics) of charging and discharging with large currents under the necessity of a quick charge or a high load discharge. Additionally, in the non-aqueous electrolyte secondary batteries used in the electrically powered vehicles, the large-sized electricity storage systems, or the like, the required battery life is longer, compared with that of small mobile electronic equipment, and it is important that the battery characteristics do not decrease even as charge and discharge cycle proceeds.

As the non-aqueous electrolyte secondary battery with a high capacity and a high energy density, a non-aqueous electrolyte secondary battery having a stacked electrode assembly in which a positive and a negative electrode plates with a large area are stacked interposing separators therebetween, is effective. However, in the non-aqueous electrolyte battery having a stacked electrode assembly in which the positive and the negative electrode plates with a large area are stacked interposing separators therebetween, it is difficult that a gas generated by the decomposition of an electrolyte or the like shifts from the inside of the electrode assembly to the outside. Therefore, charging and discharging reaction becomes ununiform, and it causes a problem that deterioration with charge and discharge cycles is accelerated.

In a spiral electrode assembly in which an elongated positive electrode plate and an elongated negative electrode plate interposing a separator therebetween are spirally wound, by expansion and contraction of the electrode assembly with charging and discharging, the electrode assembly easily loosens or deforms, and a gas generated inside the electrode assembly easily shifts outside the electrode assembly. In contrast, in the stacked electrode assembly, as the pressure applied to the each portion is approximately uniform, by expansion and contraction of the electrode assembly with charging and discharging, the electrode assembly hardly loosens or deforms, and a gas generated inside the electrode assembly hardly shifts outside the electrode assembly. Therefore, in the stacked electrode assembly containing electrode plates with a large area, as the pressure applied to the each portion is approximately uniform, even by expansion and contraction of the electrode assembly with charging and discharging, the electrode assembly hardly loosens or deforms, and a gas generated inside the electrode assembly hardly shifts. Accordingly, the non-aqueous electrolyte secondary battery having the stacked electrode assembly containing the electrode plates with a large area remarkably deteriorates with charge and discharge cycles, compared with the non-aqueous electrolyte secondary battery having the cylindrical spiral electrode assembly.

On the other hand, in order to obtain the non-aqueous electrolyte secondary battery excellent in the load characteristics, it is preferable to use a lithium transition-metal composite oxide as the positive electrode active material which is synthesized under the lithium rich condition to the transition-metal. Here, related art documents which disclose the lithium transition-metal composite oxide as the positive electrode active material which is synthesized under the lithium rich condition to the transition-metal are, for example, patent literature 1, and patent literature 2.

### CITATION LIST

### Patent Literature

Patent Literature 1:
Japanese Laid-Open Patent Publication No. 2006-73482

Patent Literature 2:
Japanese Laid-Open Patent Publication No. 2008-270086

### SUMMARY OF THE INVENTION

However, when a lithium transition-metal composite oxide as the positive electrode active material which is synthesized under the lithium rich condition to the transition-metal is used, a gas generation by ununiform reaction caused by decomposition of remaining lithium oxide or electric resistance of remaining lithium oxide becomes remarkable, causing a problem that the non-aqueous electrolyte secondary battery having the stacked electrode assembly containing each electrode plate with a large area hardly obtains the excellent battery characteristics, and especially that charge and discharge cycle characteristics (high temperature cycle characteristics) decreases under the high temperature condition.

The present disclosure is developed for solving the aforementioned problem, and aims to provide a non-aqueous electrolyte secondary battery that exhibits the excellent high temperature cycle characteristics.

A non-aqueous electrolyte secondary battery of the present disclosure comprises square positive electrode plates provided with a positive electrode active material layer formed on a surface of a positive electrode core in each of the positive electrode plates, square negative electrode plates provided with a negative electrode active material layer formed on a surface of a negative electrode core in each of the negative electrode plates, and an outer case storing a non-aqueous electrolyte and a stacked electrode assembly in which the positive electrode plates and the negative electrode plates are stacked interposing separators therebetween, and each of the width and the height of the positive electrode plates is 100 mm or more, and each of the width and the height of the negative electrode plates is 100 mm or more, and the stacked electrode assembly in which 10 sheets or more of the positive electrode plates and 10 sheets or more of the negative electrode plates are stacked interposing the separators therebetween, and the positive electrode active material layer comprises a lithium transition-metal composite oxide expressed by Liₐ(Ni_{b}Co_{c}Mn_{d})MₑO₂ (1.05≦a≦1.20, 0.3≦b≦0.6, b+c+d=1, 0≦e≦0.05 as the positive electrode active material, and M is at least one element selected from the group consisting of Ti, Nb, Mo, Zn, Al, Sn, Mg, Ca, Sr, Zr, and W), and the non-aqueous electrolyte contains non-aqueous solvent and electrolyte salt, and the proportion of a chain carbonate contained in the non-aqueous solvent to the non-aqueous solvent is 50% by volume or more, and the proportion of diethyl carbonate contained in the chain carbonate to the chain carbonate is 70% by volume or more.

According to the present disclosure, the non-aqueous electrolyte secondary of high capacity is obtained, comprising each of the width and the height of the positive electrode plates is 100 mm or more, and each of the width and the height of the negative electrode plates is 100 mm or more, and the stacked electrode assembly in which 10 sheets or more of the positive electrode plates and 10 sheets or more of the negative electrode plates are stacked interposing the separators therebetween. Furthermore, the positive electrode active material layer comprises a lithium transition-metal composite oxide expressed by Liₐ(Ni_{b}Co_{c}Mn_{d})MₑO₂ (1.05≦a≦1.20, 0.3≦b≦0.6, b+c+d=1, 0≦e≦0.05, and M is at least one element selected from the group consisting of Ti, Nb, Mo, Zn, Al, Sn, Mg, Ca, Sr, Zr, and W), and the non-aqueous electrolyte contains non-aqueous solvent and electrolyte salt, and the proportion of the chain carbonate contained in the non-aqueous solvent to the non-aqueous solvent is 50% by volume or more, and the proportion of diethyl carbonate contained in the chain carbonate to the chain carbonate is 70% by volume or more. Accordingly, even the non-aqueous electrolyte secondary battery having the stacked electrode assembly using positive electrode plates and negative electrode plates with a large area exhibits the excellent high temperature cycle characteristics.

Here, in the present disclosure, the length of the side in which a current collector tab is provided with each electrode plate is defined as “width”, and the length of the side perpendicular to the side having the current collector tab is defined as “height”. Further, “width” or “height” is a length of a region where the electrode active material is formed.

Moreover, in the present disclosure, by using the stacked electrode assembly in which 10 sheets or more of each of the positive electrode plate and the negative electrode plate are stacked, the deformation resistant strength is improved, and the non-aqueous electrolyte secondary battery stable against an impact is obtained.

In the present disclosure, it is preferable that the chain carbonate is at least one selected from the group consisting of dimethyl carbonate, diethyl carbonate, and methyl ethyl carbonate.

In the present disclosure, it is preferable to use the lithium transition-metal composite oxide expressed by Liₐ(Ni_{b}Co_{c}Mn_{d})MₑO₂ (1.05≦a≦1.20, 0.3≦b≦0.6, 0<c, 0<d, b+c+d=1, 0≦e≦0.05, and M is at least one element selected from the group consisting of Ti, Nb, Mo, Zn, Al, Sn, Mg, Ca, Sr, Zr, and W) as the positive electrode active material.

Since Co and Mn together with excess Li exist within the structure of the lithium transition-metal composite oxide as the positive electrode active material, the crystal structure is stabilized, and then the non-aqueous electrolyte secondary battery excellent in the cycle characteristics is obtained. Further, as at least one element selected from the group consisting of Ti, Nb, Mo, Zn, Al, Sn, Mg, Ca, Sr, Zr exists within the structure of the lithium transition-metal composite oxide, the non-aqueous electrolyte secondary battery excellent in cycle characteristics is obtained.

In the present disclosure, it is preferable that the negative electrode active material layer contains a rubber-based binder. As a binder in the negative electrode active material layer, it is possible to use polyvinylidene fluoride. As polyvinylidene fluoride is low in binding property and swelling property, it is necessary to increase a content of polyvinylidene fluoride in the negative electrode active material. Therefore, in the non-aqueous electrolyte secondary battery having the stacked electrode assembly containing electrode plates with a large area, charging and discharging reaction tends to become ununiform, and it is difficult to improve the cycle characteristics. In contrast, as the rubber-based binder is excellent in binding property and swelling property, by using the rubber-based binder as a binder of the negative electrode active material layer, the non-aqueous electrolyte secondary battery excellent in the cycle characteristics is obtained.

In the present disclosure, the non-aqueous electrolyte preferably contains 0.5 to 4.0% by mass of vinylene carbonate to the non-aqueous solvent.

Accordingly, a good film is formed on the surface of the negative electrode plate, and it reduces or suppresses a gas generation by decomposition of the electrolyte. Hence, the non-aqueous electrolyte secondary battery excellent in high temperature cycle property is obtained.

In the present disclosure, the outer case is made of a laminated film in which resin layers are formed on both surfaces of a metal foil, and it is preferable that the outer case is sealed in a state of reduced pressure.

Accordingly, as the stacked electrode assembly is uniformly pressed, charging and discharging reaction tends to uniformly occur, and then the non-aqueous electrolyte secondary battery excellent in cycle property is obtained.

### BRIEF DESCRIPTION OF DRAWINGS

FIG. 1 is a perspective view of a lithium ion battery related to an embodiment of the present invention

FIG. 2A is a plan view of a positive electrode plate used in the lithium ion battery related to the embodiment of the present invention, FIG. 2B is a plan view of a negative electrode plate used in the lithium ion battery related to the embodiment of the present invention.

FIG. 3 is a perspective view of a stacked electrode assembly used in the lithium ion battery related to the embodiment of the present invention.

FIG. 4 is a perspective view of a cylindrical spiral electrode assembly used in a cylindrical lithium ion battery related to reference example.

### DESCRIPTION OF EMBODIMENTS

Hereinbelow, preferred embodiments of the present invention are described in detail, but the present invention is not limited to the following preferred embodiments, and then various changes and modifications are possible unless such changes and variations depart from the scope of the invention.

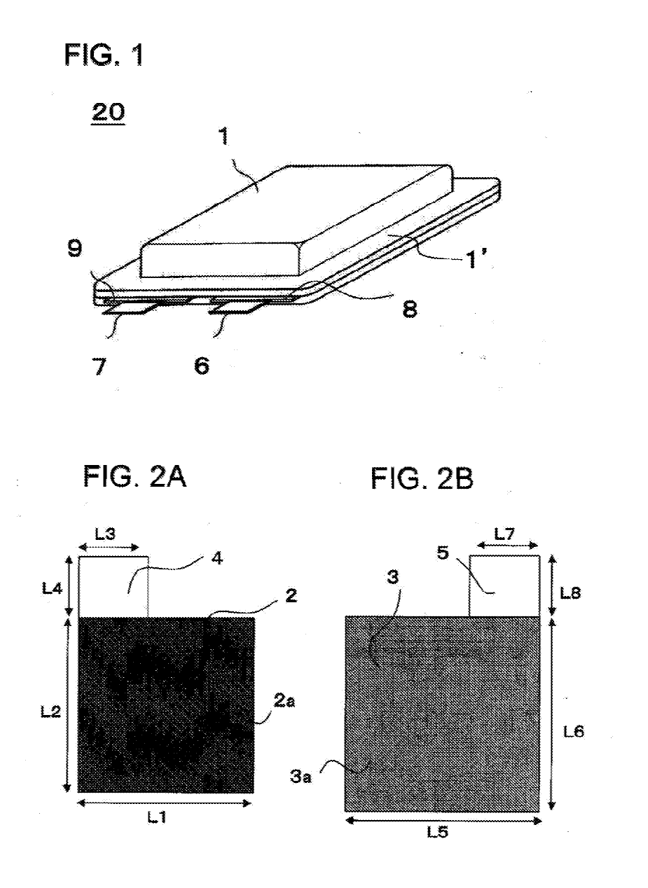

As the non-aqueous electrolyte secondary battery related to an embodiment of the present invention, a lithium ion battery 20 having a laminate outer case is explained based on FIG. 1 to FIG. 3.

As shown in FIG. 1, the lithium ion battery 20 stores a stacked electrode assembly 10 and a non-aqueous electrolyte inside the laminate outer case 1, and a positive terminal 6 and a negative terminal 7 connected to a positive electrode current collector tab 4 and a negative electrode current collector tab 5, respectively, project from a welding sealing portion 1′ of the laminate outer case 1. At the welding sealing portion 1′ of the laminate outer case 1, a positive tab resin 8 is disposed between the positive terminal 6 and the laminate outer case, and a negative tab resin 9 is disposed between the negative terminal 7 and the laminate outer case 1.

As shown in FIG. 2A, in a positive electrode plate 2, a positive electrode active material layer 2a is formed on both surfaces of a positive electrode core, and a positive electrode core having no positive electrode active material layer 2a formed thereon projects from one end portion to serve as the positive electrode current collector tab 4. As shown in FIG. 2B, in a negative electrode plate 3, a negative electrode active material layer 3a is formed on both surfaces of a negative electrode core, and a negative electrode core having no negative electrode active material layer 3a formed thereon projects from one end portion to serve as the positive electrode current collector tab 5.

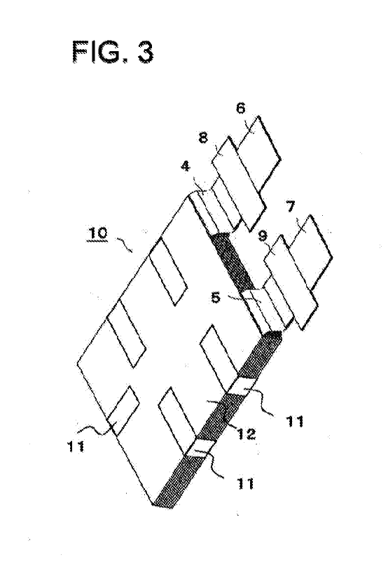

As shown in FIG. 3, in the stacked electrode assembly 10, a positive electrode plate 2 and a negative electrode plate 3 are alternately stacked interposing the separators therebetween, and the negative electrode plates 3 are disposed at both of the outmost surfaces. Further, insulation sheets 12 are disposed at those outmost surfaces, and are fixed by insulation tapes 11. In the stacked electrode assembly 10, the positive electrode current collector tab 4 and the negative electrode current collector tab 5 project in the same direction, and the positive electrode current collector tabs 4 and the negative electrode current collector tabs 5 are each stacked. The stacked positive electrode current collector tab 4 and the negative electrode current collector tab 5 are respectively connected to the positive terminal 6 and the negative terminal 7 by ultrasonic welding.

The stacked electrode assembly 10 is inserted between a laminated film of a cup shape to store the stacked electrode assembly 10 and a laminated film of a sheet shape. Further, three sides on the periphery are thermally welded such that the positive electrode current collector tab 4 and the negative electrode current collector tab 5 project from the welding sealing portion 1′ of the laminate outer case. After that, the non-aqueous electrolyte is injected through an opening portion which is not thermally welded in the laminate outer case 1. Subsequently, by thermally welding the opening portion of the laminate outer case 1, the lithium ion battery 20 is made.

Next, a manufacturing method of the lithium ion battery 20 related to an embodiment of the present invention is explained using example 1.

### Example 1

### Preparation of Positive Electrode Plate

Li_{1.10}(Ni_{0.3}Co_{0.4}Mn_{0.3})O₂ as the positive electrode active material, carbon black as a conductive agent, and polyvinylidene fluoride (PVdF) as a binder were mixed in the ratio of 94:3:3 by mass. The resultant mixture was dispersed in N-methyl-2-pyrrolidone (NMP) as a solvent to make a positive electrode mixture slurry. This positive electrode mixture slurry was coated on both surfaces of an aluminum foil (20 μm (=micrometer) in thickness) by the doctor blade method. After that, the solvent was removed by heat, and it was pressed with a roll press so as to have a thickness of 0.2 mm, and then by cutting it into the size of the width L1=150 mm and the height L2=150 as shown in FIG. 2A, the positive electrode plate 2 having the positive electrode active material 2a on both surfaces was made. At this time, the positive electrode current collector tab 4 was made by extending the positive electrode core of the size of the width L3=30 mm and the height L4=20 from the end portion of the positive electrode plate 2 without the positive electrode active material layer 2a.

### [Preparation of Negative Electrode Plate]

The graphite as the negative electrode active material, carboxymethylcellulose (CMC) as a thickener, and styrene-butadiene rubber (SBR) as a bindery were mixed in the ratio of 98:1:1 by mass and the mixture was dispersed in water to make a negative electrode mixture slurry. After that, this negative electrode mixture slurry was coated on both surfaces of a copper foil (10 μm (=micrometer) in thickness) by the doctor blade method. After that, water was removed by heat, and it was pressed with a roll press so as to have a thickness of 0.2 mm, and then by cutting it into the size of the width L5=155 mm and the height L6=150 as shown in FIG. 2B, the negative electrode plate 3 having the negative electrode active material 3a on both surfaces was made. At this time, the negative electrode current collector tab 5 was made by extending the negative electrode core of the size of the width L7=30 mm and the height L8=20 from the end portion of the negative electrode plate 3 without the negative electrode active material layer 3a.

### [Preparation of Non-Aqueous Electrolyte]

Ethylene carbonate (EC) and diethyl carbonate (DEC) were mixed in the proportion of 30:70 by volume. LiPF₆ as an electrolyte salt was dissolved to be 1.2 mol/L. Vinylene carbonate (VC) was added so as to provide the ratio of 3% by mass to the non-aqueous electrolyte solvent, to prepare the non-aqueous electrolyte. Here, the volume ratio of each solvent in the non-aqueous electrolyte in this embodiment of the present invention is a ratio under the condition of 25° C. (degree Celsius) and 1 atmosphere.

### [Preparation of Stacked Electrode Assembly]

20 sheets of the positive electrode plates 2 made in the above method and 21 sheets of the negative electrode plates 3 made in the above method were alternately stacked interposing the separators a separator made of polyethylene microporous membrane (155 mm×155 mm, 20 μm in thickness) therebetween, and the stacked electrode assembly 10 was made. Here, in the stacked electrode assembly 10, the negative electrode plates 3 were disposed at both of the outmost surfaces, and insulation sheets 12 were disposed at those outmost surfaces, and were fixed by insulation tapes 11.

### [Welding of Current Collector Tab]

The positive electrode current collector tab 4 of each of the positive electrode plates 2 was bundled in a bundle, and connected to the positive terminal 6 made of an aluminum plate (30 mm in width, 50 mm in height, 0.4 mm in thickness) by ultrasonic welding. Furthermore, the negative electrode current collector tab 5 of each of the positive electrode plates 2 was bundled in a bundle, and connected to the negative terminal 7 made of a copper plate (30 mm in width, 50 mm in height, 0.4 mm in thickness) by ultrasonic welding. Here, the positive tab resin 8 and the negative tab resin 9 were respectively glued to the positive terminal 6 and the negative terminal 7. As mentioned below, the positive tab resin 8 was disposed between the positive terminal 6 and the laminate outer case, and the negative tab resin 9 was disposed between the negative terminal 7 and the laminate outer case 1. In that way, by improving adhesive property between the positive and negative terminals 6, 7 and the laminate outer case 1, the sealing property of the laminate outer case 1 was improved.

[Insertion into Outer Case]

The stacked electrode assembly 10 made in the above method was inserted into the laminate outer case 1 which was formed in a cup shape so as to store the electrode assembly in advance. Excluding one side of three sides except the side where the positive terminal 6 and the negative terminal 7 were disposed, the three sides were thermally welded such that only the positive terminal 6 and the negative terminal 7 project from the laminate outer case 1. Here, the positive tab resin 8 was disposed between the positive terminal and the laminate outer case 1, and the negative tab resin 9 was disposed between the negative terminal 7 and the laminate outer case 1.

### [Injection of Non-aqueous Electrolyte and Sealing]

The non-aqueous electrolyte prepared in the above method was injected through the one side which was not thermally welded in the laminate outer case 1. After that, the one side which had not been thermally welded in the laminate outer case 1 was sealed by thermal welding in a state of reducing the pressure inside the laminate outer case 1, and the lithium ion battery of example 1 was made.

### Example 2

For a non-aqueous electrolyte, EC and DEC were mixed in the proportion of 20:80 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of example 2 was made in the same way as example 1.

### Example 3

For a non-aqueous electrolyte, EC, DEC, and methyl ethyl carbonate (MEC) were mixed in the proportion of 30:49:21 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of example 3 was made in the same way as example 1.

### Example 4

For a non-aqueous electrolyte, EC, propylene carbonate (PC), and DEC were mixed in the proportion of 20:10:70 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of example 4 was made in the same way as example 1.

### Example 5

For a non-aqueous electrolyte, EC, and DEC were mixed in the proportion of 50:50 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of example 5 was made in the same way as example 1.

### Comparative Example 1

For a non-aqueous electrolyte, EC, DEC, and MEC were mixed in the proportion of 30:35:35 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of comparative example 1 was made in the same way as example 1.

### Comparative Example 2

For a non-aqueous electrolyte, EC, and DEC were mixed in the proportion of 60:40 by volume, and LiPF₆ as an electrolyte salt was dissolved to be 1.2 mol/L. VC was added to the solution so as to provide the ratio of 3% by mass to the non-aqueous solvent, to prepare the non-aqueous electrolyte. Except the above, the lithium ion battery of comparative example 2 was made in the same way as example 1.

### Example 6

As the positive electrode active material, Li_{1.20}(Ni_{0.3}Co_{0.4}Mn_{0.3})O₂ was used. Except the above, the lithium ion battery of example 6 was made in the same way as example 1.

### Example 7

As the positive electrode active material, Li_{1.06}(Ni_{0.3}Co_{0.4}Mn_{0.3})O₂ was used. Except the above, the lithium ion battery of example 7 was made in the same way as example 1.

### Example 8

As the positive electrode active material, Li_{1.10}(Ni_{0.5}Co_{0.2}Mn_{0.3})O₂ was used. Except the above, the lithium ion battery of example 8 was made in the same way as example 1.

### Example 9

As the positive electrode active material, Li_{1.10}(Ni_{0.6}Co_{0.2}Mn_{0.2})O₂ was used. Except the above, the lithium ion battery of example 9 was made in the same way as example 1.

### Example 10

As the positive electrode active material, Li_{1.10}(Ni_{0.6}Co_{0.1}Mn_{0.3})O₂ was used. Except the above, the lithium ion battery of example 10 was made in the same way as example 1.

### Comparative Example 3

As the positive electrode active material, Li_{1.03}(Ni_{0.3}Co_{0.4}Mn_{0.3})O₂ was used. Except the above, the lithium ion battery of comparative example 3 was made in the same way as example 1.

### Comparative Example 4

As the positive electrode active material, Li_{1.10}(Ni_{0.8}Co_{0.2})O₂ was used. Except the above, the lithium ion battery of comparative example 4 was made in the same way as example 1.

### Comparative Example 5

As the positive electrode active material, L_{1.10}(Ni_{0.8}Co_{0.01}Mn_{0.1})O₂ was used. Except the above, the lithium ion battery of comparative example 5 was made in the same way as example 1.

### Comparative Example 6

As the positive electrode active material, Li_{1.10}(Ni_{0.2}Co_{0.8})O₂ was used. Except the above, the lithium ion battery of comparative example 6 was made in the same way as example 1.

### Reference Example 1

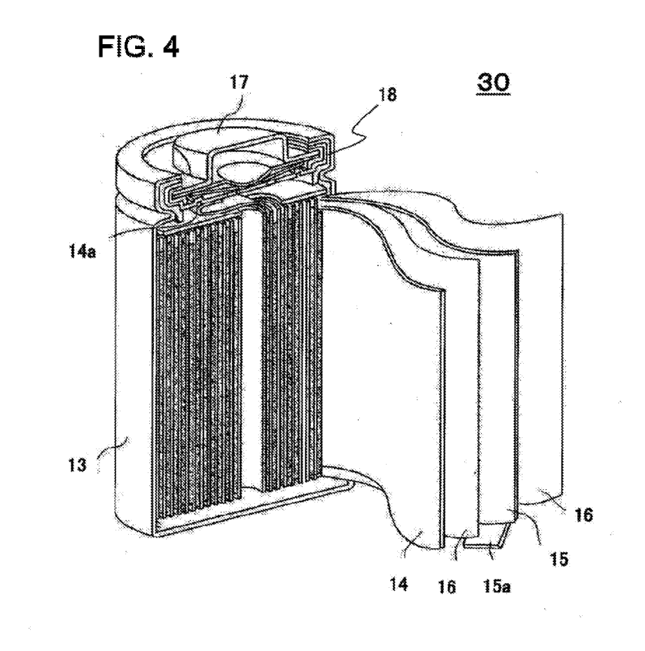

Using a positive electrode plate and a negative electrode made in the same way as example 1 plate except the width and the height, a spiral electrode assembly (spiral turn number: 21) was made. The cylindrical lithium ion battery of reference example 1 was made. The positive electrode plate was an elongated shape of 56 mm in width and 590 mm in height, and the negative electrode plate was an elongated shape of 60 mm in width and 600 mm in height. As shown in FIG. 4, in the cylindrical lithium ion battery 30, the elongated positive electrode plate 14 and the elongated negative electrode plate 15 interposing a separator 16 of an elongated shape therebetween were spirally wound, and the spiral electrode assembly was made. And then, the spiral electrode assembly and the non-aqueous electrolyte prepared in example 1 were stored inside an outer can 13 of a tubular shape having a bottom portion. An opening portion of the outer can 13 was sealed by a sealing plate 17, and the outer can 13 and the sealing plate 17 were electrically insulated from each other by an insulating gasket 18 sandwiched therebetween. The positive electrode lead 14a connected to the positive electrode plate 14 was connected to the sealing plate 17, and then the sealing plate 17 served as a positive terminal. Furthermore, the negative electrode lead 15 a connected to the negative electrode plate 15 was connected to the outer can 13, and then the outer can 13 served as a negative terminal.

### Reference Example 2

For a non-aqueous electrolyte, EC, DEC, and MEC were mixed in the proportion of 30:35:35 by volume, and LiPF₆ as an electrolyte salt was dissolved to be 1.2 mol/L. VC was added to the solution so as to provide the ratio of 3% by mass to the non-aqueous electrolyte solvent, to prepare the non-aqueous electrolyte. Except the above, the lithium ion battery of reference example 2 was made in the same way as reference example 1.

### Reference Example 3

The positive electrode plate 2 had a size of the width and the height 150 mm×75 mm, and the negative electrode plate 3 had a size of the width and the height 155 mm×80 mm. Except the above, the lithium ion battery of reference example 3 was made in the same way as example 1.

### Reference Example 4

The positive electrode plate 2 had a size of the width and the height 150 mm×75 mm, and the negative electrode plate 3 had a size of the width and the height 155 mm×80 mm. Except the above, the lithium ion battery of reference example 3 was made in the same way as comparative example 1.

### [High Temperature Cycle Test]

At 50° C. (degree Celsius), the lithium ion batteries of examples 1 to 10, comparative examples 1 to 6, and reference example 1 to 4 were charged with a constant current (1 C, charge end voltage 4.2 V)−a constant voltage (4.2 V, charge end current 1/50 C). After that, the batteries were discharged with a constant current of 2 C up to 3.0 V. Such charging and discharging were taken as the first cycle. The charge and discharge cycle on the same condition as that of the first cycle was repeated 400 times, and the ratio (%) of the discharge capacity at the 400th cycle to the discharge capacity at the first cycle was calculated as a capacity retention rate (%).

Capacity retention rate(%)=(400th cycle discharge capacity/first cycle discharge capacity)×100

The results of high temperature cycle test in examples 1 to 10, comparative examples 1 to 6, and reference example 1 to 4 are shown in Table 1 to 4.

TABLE 1

| | non-aqueous solvent | | | | proportion of DEC | capacity |
|---|---|---|---|---|---|---|
| | (by volume %) | | | | to chained | retention |
| | EC | PC | DEC | MEC | carbonate (%) | rate (%) |
| Example 2 | 20 | — | 80 | — | 100 | 86 |
| Example 1 | 30 | — | 70 | — | 100 | 86 |
| Example 3 | 30 | — | 49 | 21 | 70 | 85 |
| Com. Ex. 1 | 30 | — | 35 | 35 | 50 | 79 |
| Example 4 | 20 | 10 | 70 | — | 100 | 86 |
| Example 5 | 50 | — | 50 | — | 100 | 84 |
| Com. Ex. 2 | 60 | — | 40 | — | 100 | 79 |

Table 1 shows the results of high temperature cycle test of examples 1 to 5, and comparative example 1, 2, each of which employed Li_{1.10}(Ni_{0.3}Co_{0.4}Mn_{0.3})O₂ as the positive electrode active material. In each of examples 1 to 5, in which the proportion of the chain carbonate to the non-aqueous solvent was 50% by volume or more and the proportion of DEC to the chain carbonate was 70% by volume or more, the capacity retention rate was high values of 84 to 86%. In contrast, in comparative example 1, in which the proportion of DEC to chain carbonate was 50% by volume, was a low values of 79%. In addition, in comparative example 2, in which the proportion of the chain carbonate to the non-aqueous solvent was 50% by volume, the capacity retention rate was a low value of 79%. These results show that the non-aqueous electrolyte secondary battery with the excellent high temperature cycle characteristics, in which the lithium rich positive electrode active material is used, can be obtained when the proportion of the chain carbonate to the non-aqueous solvent is 50% by volume or more and the proportion of DEC to chained carbonate is 70% by volume or more.

TABLE 2

| | | capacity retention |
|---|---|---|
| | positive electrode active material | rate (%) |
| Example 6 | Li_{1.20}(Ni_{0.3}Co_{0.4}Mn_{0.3})O₂ | 87 |
| Example 1 | Li_{1.10}(Ni_{0.3}Co_{0.4}Mn_{0.3})O₂ | 86 |
| Example 7 | Li_{1.06}(Ni_{0.3}Co_{0.4}Mn_{0.3})O₂ | 86 |
| Com. Ex. 3 | Li_{1.03}(Ni_{0.3}Co_{0.4}Mn_{0.3})O₂ | 79 |
| Example 8 | Li_{1.10}(Ni_{0.5}Co_{0.2}Mn_{0.3})O₂ | 85 |
| Example 9 | Li_{1.10}(Ni_{0.6}Co_{0.2}Mn_{0.2})O₂ | 85 |
| Example 10 | Li_{1.10}(Ni_{0.6}Co_{0.1}Mn_{0.3})O₂ | 85 |
| Com. Ex. 4 | Li_{1.10}(Ni_{0.8}Co_{0.2})O₂ | 79 |
| Com. Ex. 5 | Li_{1.10}(Ni_{0.8}Co_{0.1}Mn_{0.1})O₂ | 78 |
| Com. Ex. 6 | Li_{1.10}(Ni_{0.2}Co_{0.8})O₂ | 79 |

Table 2 shows the results of high temperature cycle test of examples 1, 6 to 10, and comparative example 3 to 6, in which the composition of the non-aqueous solvent was PC:DEC=30:70 by volume ratio. In each of examples 1, 6 to 10, the amount of Li (Li molar ratio of composition formula) in the positive electrode active material is 1.06 or more, and the amount of Ni (Ni molar ratio of composition formula) in the positive electrode active material is 0.3 to 0.6. In each of examples 1, 6 to 10, the capacity retention rate was high values of 85 to 87%. In contrast, in comparative example 3, in which the amount of Li amount was 1.03 in the positive electrode active material, the capacity retention rate was a low value of 79%. In addition, in comparative example 6, in which the amount of Ni was 0.2 in the positive electrode active material, and in comparative example 4 and 5, in which the amounts of Ni was 0.8 in the positive electrode active material, the capacity retention rates were low values of 78 to 79%. From these results, the amount of Li in the positive electrode active material is required to be 1.05 to 1.20 and the amount of Ni in the positive electrode active material is required to be 0.3 to 0.6 in order to obtain the non-aqueous electrolyte secondary battery with the excellent high temperature cycle characteristics.

TABLE 3

| | | | | proportion | | | |
|---|---|---|---|---|---|---|---|
| | | | | of DEC | negative electrode | | |
| | non-aqueous solvent | | | to chained | plate of | | capacity |
| | (by volume %) | | | carbonate | width (mm) × | electrode | retention |
| | EC | DEC | MEC | (%) | height (mm) | assembly | rate (%) |
| Example 1 | 30 | 70 | — | 100 | 155 × 155 | stacked | 86 |
| Ref. Ex. 1 | 30 | 70 | — | 100 | 60 × 600 | spiral | 82 |
| Com. Ex. | 30 | 35 | 35 | 100 | 115 × 155 | stacked | 79 |
| 1 | | | | | | | |
| Ref. Ex. 2 | 30 | 35 | 35 | 100 | 60 × 600 | spiral | 83 |

Table 3 shows the results of high temperature cycle test of examples 1, comparative example 1, and reference example 1, 2 of which the positive electrode active materials were Li_{1.10}(Ni_{0.3}Co_{0.4}Mn_{0.3})O₂. The comparison between reference example 1 and reference example 2 shows that the high temperature characteristics were scarcely influenced by the difference in the composition of the non-aqueous solvent in the cylindrical lithium ion battery having the spiral electrode assembly. In addition, even in reference example 2, in which the proportion of DEC to chain carbonate was 50% by volume, the capacity retention rate was a comparatively high value of 82%. It is assumed that in the spiral electrode assembly, compared with the stack type electrode assembly, a gas generated inside the electrode assembly during high temperature cycle easily shifts outside the electrode assembly and the capacity decrease is small in charge and discharge cycle under high temperature condition. These results indicates that the capacity decrease in charge and discharge cycle under high temperature condition is a peculiar problem of the non-aqueous electrolyte secondary battery having the stacked electrode assembly containing electrode plates with a large area. Here, the non-aqueous electrolyte secondary battery having the spiral electrode assembly has a problem that it is difficult to obtain a high capacity battery.

TABLE 4

| | | | | proportion | negative | |
|---|---|---|---|---|---|---|
| | non-aqueous | | | of DEC | electrode | |
| | sotvent | | | to chained | plate of | capacity |
| | (by volume %) | | | carbonate | width (mm) × | retention |
| | EC | DEC | MEC | (%) | height (mm) | rates (%) |
| Example 1 | 30 | 70 | — | 100 | 155 × 155 | 86 |
| Ref. Ex. 3 | 30 | 70 | — | 100 | 155 × 80 | 85 |
| Com. Ex. 1 | 30 | 35 | 35 | 100 | 155 × 155 | 79 |
| Ref. Ex. 4 | 30 | 35 | 35 | 100 | 155 × 80 | 85 |

Table 4 shows the results of high temperature cycle test of examples 1, comparative example 1, and reference example 3, 4 of which the positive electrode active material were Li_{1.10}(Ni_{0.3}Co_{0.4}Mn_{0.3})O₂. From Table 4, the following is evident. When the height of the negative electrode plate is 80 mm, the composition of the non-aqueous solvent scarcely influences the capacity retention rate. In contrast, when both the width and the height of the negative electrode plate are 155 mm, the composition of the non-aqueous solvent greatly influences the capacity retention rate. From these results, it is assumed that the problem of the capacity decrease in charge and discharge cycle under high temperature condition is a peculiar problem of the non-aqueous electrolyte secondary battery having the stacked electrode assembly containing electrode plates with a large area of 100 mm or more in both width and length. Here, when one side of an electrode plate is less than 100 mm in length, it is difficult to obtain a high capacity secondary battery.

From the above results, in the embodiment of the present invention, by using the specific lithium transition-metal composite oxide and the non-aqueous electrolyte containing the specific composition of non-aqueous solvent, even the non-aqueous electrolyte secondary battery having the stacked electrode assembly having stacked positive electrode plates and negative electrode plates with a large area exhibits the excellent high temperature cycle characteristics.

In the embodiment of the present invention, as negative electrode active material, graphite, graphitized pitch-based carbon fiber, non-graphitized carbon, easily graphitizable carbon, pyrolytic carbon, glassy carbon, organic high molecular compound burning body, carbon fiber, activated carbon, coke, tin oxide, silicon, silicon oxide, or the like and mixtures of them can be used.

In the embodiment of the present invention, as non-aqueous solvent of non-aqueous electrolyte, carbonates, lactones, ethers, ketones, esters or the like, which are commonly used in a non-aqueous electrolyte secondary battery can be used singly or in combination of two or more. Especially, it is desirable that cyclic carbonates such as ethylene carbonate, propylene carbonate, butylene carbonate, or the like, and chained carbonates such as dimethyl carbonate, ethyl methyl carbonate, diethyl carbonate, or the like are mixed. Further, unsaturated cyclic carbonate ester such as vinylene carbonate or the like can be added to the non-aqueous electrolyte

In the embodiment of the present invention, lithium salts commonly used as the electrolyte salt in a non-aqueous electrolyte secondary battery can be used as electrolyte salts in the non-aqueous solvent. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiCIO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, or the like and mixtures of them can be used. Among them, especially LiPF₆ is desirable. The amount of electrolyte salt dissolved in the non-aqueous solvent is preferably 0.5 to 2.0 mol/L.

In the embodiment of the present invention, besides the laminate outer case as the outer case, an outer can made of metal can be used. As the laminate outer case, a laminated film of resin layers formed on both surfaces of a metal sheet can be used. For example, the laminated film can be used which is constituted of aluminum, aluminum alloy, stainless or the like for the metal layer, polyethylene, polypropylene or the like for the inner layer (the battery inside), and nylon, polyethylene-terephthalate (PET), a stacked sheet of PET/nylon, or the like for the outer layer (the battery outer side).

### REFERENCE MARKS IN THE DRAWINGS

1: laminate outer case
1′: welding sealing portion
2: positive electrode plate
3: negative electrode plate
4: positive electrode current collector tab
5: negative electrode current collector tab
6: positive terminal
7: negative terminal
8: positive tab resin
9: negative tab resin
10: stacked electrode assembly
11: insulation tape
12: insulation sheet
13: outer can
14: positive electrode plate 14
14a: positive electrode lead
15: negative electrode plate
15a: negative electrode lead
16: separator
17: sealing plate
18: insulating gasket
30: cylindrical lithium ion battery

1. A non-aqueous electrolyte secondary battery comprising:
square positive electrode plates provided with a positive electrode active material layer formed on a surface of a positive electrode core in each of the positive electrode plates;
square negative electrode plates provided with a negative electrode active material layer formed on a surface of a negative electrode core in each of the negative electrode plates; and
an outer case storing a non-aqueous electrolyte and a stacked electrode assembly in which the positive electrode plates and the negative electrode plates are stacked interposing separators therebetween,
wherein each of the width and the height of the positive electrode plates is 100 mm or more, and each of the width and the height of the negative electrode plates is 100 mm or more, and the stacked electrode assembly in which 10 sheets or more of the positive electrode plates and 10 sheets or more of the negative electrode plates are stacked interposing the separators therebetween,
wherein the positive electrode active material layer comprises a lithium transition-metal composite oxide expressed by Liₐ(Ni_{b}Co_{c}Mn_{d})MₑO₂ (1.05≦a≦0.20, 0.3≦b≦3.6, b+c+d=1, 0≦e≦0.05, and M is at least one element selected from the group consisting of Ti, Nb, Mo, Zn, Al, Sn, Mg, Ca, Sr, Zr, and W) as the positive electrode active material,
wherein the non-aqueous electrolyte contains non-aqueous solvent, and electrolyte salt, and the proportion of a chain carbonate contained in the non-aqueous solvent to the non-aqueous solvent is 50% by volume or more, and the proportion of diethyl carbonate contained in the chain carbonate to the chain carbonate is 70% by volume or more.

2. The non-aqueous electrolyte secondary battery according to claim 1, wherein the chain carbonate is at least one selected from the group consisting of dimethyl carbonate, diethyl carbonate, and methyl ethyl carbonate.

3. The non-aqueous electrolyte secondary battery according to claim 2, wherein the lithium transition-metal composite oxide is expressed by Liₐ(Ni_{b}Co_{c}Mn_{d})MₑO₂ (1.05≦a≦1.20, 0.3≦b≦0.6, 0<c, 0<d, b+c+d=1, 0≦e≦0.05, and M is at least one element selected from the group consisting of Ti, Nb, Mo, Zn, Al, Sn, Mg, Ca, Sr, Zr, and W).

4. The non-aqueous electrolyte secondary battery according to claim 2, wherein the lithium transition-metal composite oxide is expressed by Liₐ(Ni_{b}Co_{c}Mn_{d})MₑO₂ (1.05≦a≦1.20, 0.3≦b≦0.6, 0<c, 0<d, b+c+d=1, 0<e≦0.05, and M is at least one element selected from the group consisting of Ti, Nb, Mo, Zn, Al, Sn, Mg, Ca, Sr, Zr, and W).

5. The non-aqueous electrolyte secondary battery according to claim 1, wherein the negative electrode active material layer contains a rubber-based binder.

6. The non-aqueous electrolyte secondary battery according to claim 1, wherein the non-aqueous electrolyte contains 0.5 to 4.0% by mass of vinylene carbonate to the non-aqueous solvent.

7. The non-aqueous electrolyte secondary battery according to claim 1, wherein the outer case is made of a laminated film in which resin layers are formed on both surfaces of a metal foil, and the outer case is sealed in a state of reduced pressure.
